(19) United States
(12) Patent Application Publication
(10) Pub. No.: US 2006/0222319 A1
(43) Pub. Date: Oct. 5, 2006

(54) PRE-RECORDED DVD AD INSERTION

(75) Inventor: Samuel H. Russ, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 10/907,536

(22) Filed: Apr. 5, 2005

(51) Int. Cl. H04N 5/93

(52) U.S. Cl. 386/52

(57) ABSTRACT

Prerecorded DVD menu alteration and ad insertion. Additional material, such as commercials, previews, and computer files can be inserted into a presentation that has been saved on a storage device. The presentation can originate from a store bought DVD. The additional information can be inserted at any point during the presentation of a professionally made DVD and can be used to alter and add new information to the menu. The additional material inserted into the presentations can be tailored to fit each individual user.

### FIELD OF THE INVENTION

This invention relates in general to broadband communications systems, and more particularly, to the insertion of advertisements into a prerecorded DVD.

### DESCRIPTION OF THE RELATED ART

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, play back that recorded video as desired by the user, and transfer the video to an archival or removable storage device possibly using a DVD recorder. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Television has become so prevalent in the United States that the typical household may have two or more television sets, each television set requiring its own STT if the subscriber wishes to have access to enhanced functionality.

A networked multimedia system (NMS) is described in copending U.S. patent application Ser. No. 10/342,670, filed Jan. 15, 2003, the disclosure and teachings of which are hereby incorporated by reference. The NMS allows a plurality of remote devices in the premises to be locally networked (i.e., home-networked). One of the remote devices typically acts as the server or primary device (i.e., the primary set-top terminal (STT)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example.

This new technology also allows users to easily maneuver between scenes of a presentation. Most often, users tend to fast forward through the commercials of a presentation. This removes a potentially important source of information from the user and reduces the attractiveness of subscriber television systems as media for advertising. Therefore, there is a need for improved methods of inserting advertisements for a targeted audience in media that was previously advertisement free, such as store bought DVDs.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 is a non-limiting example of a movie transport stream and an ad transport stream.

FIG. 3 is a non-limiting example of an MPEG stream showing I, B, and P frames and ad insertion tags.

FIG. 4 is a non-limiting example of a presentation while being manipulated with trick mode functionalities.

FIG. 5A is a non-limiting example of a root menu screen of a store bought DVD.

FIG. 5B is a non-limiting example of a root menu screen created for a DVD created by the primary device.

FIGS. 6A-6C are non-limiting examples of various options for including commercials in a presentation.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STT), a television, a computer, a personal digital assistant (PDA), or other display device. Moreover, a multi-room interactive network guide can have various features, functions, and presentations when displayed. All examples given herein, therefore, are intended to be non-limiting and are provided in order to help clarify the description of the invention.

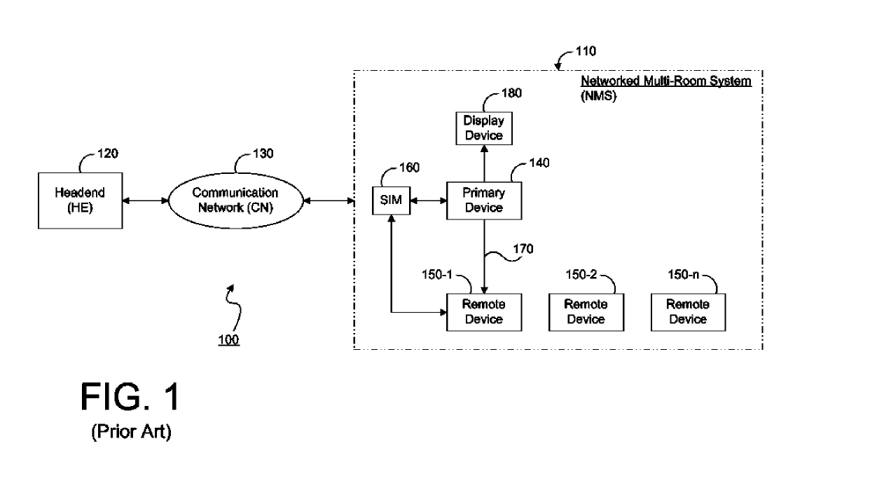

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FTTH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times.

The NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide to name but a few, to a coupled display device 180, which may be, for example, a television, computer, or PDA, among others. The primary device 140 may transmit signals to and receive control signals from the display device 180 via wireless devices (e.g., RF or IR devices) or a wired medium (e.g., coaxial cable, power lines, or telephone lines). It will also be appreciated that the primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 and just share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver, that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160.

With multi-room technology, it is possible for a user of the remote device 150-1, for example, to watch a presentation from either the primary device 140 or from the remote device 150-1. The presentation can be a previously recorded or currently tuned signal. Typically, each presentation distributed by a cable operator has a program interspersed with ads, commonly referred to as commercials. The commercials are carefully chosen and aired at times and during programs to help reach targeted audiences. By analyzing the type of presentations previously watched and recorded, commercials could be chosen that are user specific for a single user. In one embodiment of the present invention, different users in the same NMS 110 could be watching the same presentation from the primary device 140, but with different commercials.

The presentations stored in the storage device of the primary device 140 include program identifiers (PIDs), which may be indexed and stored as a table in the primary device 140's memory. The remote devices 150-1 to 150-n may watch a single stored presentation by remapping the PID value of the stored program to a different PID value prior to modulation. In this manner, the single stored program basically remains in the storage device, while the transmitted presentation is a copy of the stored presentation having a remapped PID value.

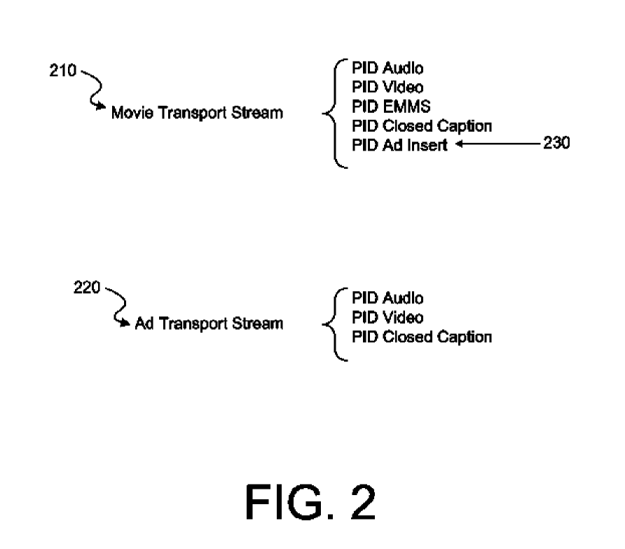

FIG. 2 illustrates a movie transport stream 210 and an ad transport stream 220. An ad insert PID 230 in the movie transport stream 210 is not activated until the presentation is cued to play or be recorded to an alternative storage device, such as a DVD. Then, the ad insert PID 230 causes the ad transport stream 220 to be incorporated into the presentation. The ad transport stream 220 can be added at specific time intervals, such as every 15 minutes or halfway through the movie, or it can replace commercials previously associated with the presentation.

While watching a previously recorded presentation from the primary device 140 on a remote device, such as 150-1, the PID associated with the presentation may be altered at the primary device 140 or at the HE 120. A PID remapper in the primary device 140's hardware inserts the ad transport stream 220 into the movie transport stream 210. The remote device 150-1 receives the presentation having a particular remapped PID value, but with the new material included such as commercials.

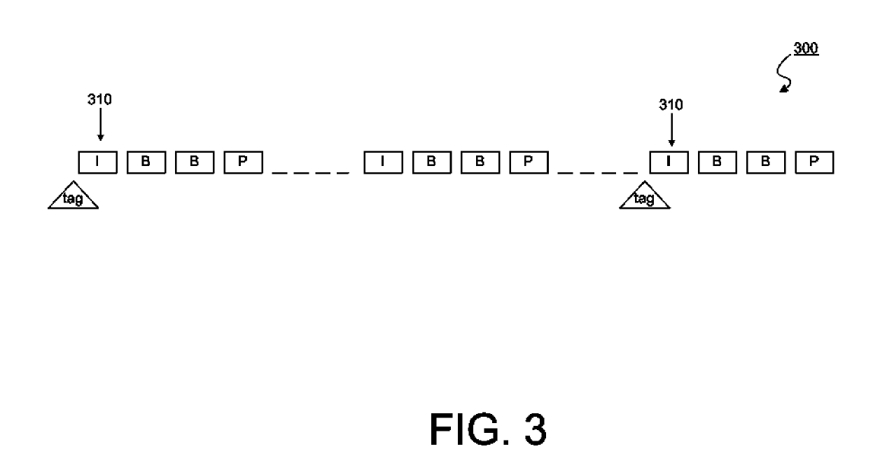

FIG. 3 illustrates a typical MPEG stream 300 including a program and commercials. In order to alter the original commercials sent with the program from the cable operator, there must be a way to differentiate between the program and the commercials. This can be accomplished using ad-insertion tags, which may be specific or multipurpose. Ad-insertion tags can be embedded in a MPEG stream 300 by the programmer responsible for creating the presentation or by the local cable operator. The broadcasting of ad-insertion tags, which were typically removed at the HE 120, is being standardized in the Digital Program Insertion (DPI) standard.

The MPEG stream is made of a series of I, P, and B frame types. The MPEG stream 300 starts with an I-frame 310, which is used as a reference for coding other frames. The I-frames are preferably tagged to indicate a splicing point when a commercial break is coming. The tags are preferably located at I-frames because each I-frame is coded using only information from within itself. For example, in picture group 300, there are two I-frames 310 tagged to indicate to the primary device 140 the location of commercials within the presentation. Also, the tags can be embedded in the vertical blanking interval information of analog broadcasts.

By knowing the location of commercials in a presentation, the primary device 140 could replace the originally provided commercials with new material saved on the primary device 140 or transmitted from the HE 120. The new material retrieved from the HE 120 or the primary device 140 could be better suited to the user based on criteria such as user preferences, previous chosen presentations, user's geographic region, recorded playback time, time dependent products or services, limited time offers, etc. For example, an advertisement could be inserted to advertise the Super Bowl at the appropriate time of year.

Also, if a user on a remote device, such as 150-2, is watching a presentation currently being tuned through the remote device 150-2 or the primary device 140, the primary device 140 can be used as the ad insertion device. When the remote device 150-2 realizes a commercial break is approaching, it notifies the primary device 140. The primary device 140 can insert replacement material into the presentation currently being viewed from the remote device 150-2. In an alternate embodiment, the primary device 140 recognizes the commercial break in the stored presentation it is transmitting to the remote device 150-2 and then PID-remaps different commercial material into the stored presentation having the same PIDs being played to the remote device, such as remote device 150-2.

Also, this same presentation can be viewed from another of the remote devices, but when this remote device notifies the primary device 140, the primary device inserts material that is different from the material that was inserted into the same presentation being viewed from the remote device 150-2. Therefore, each of the primary device 140 and the remote devices 150-1 to 150-n could be viewing the same presentation but each having different replacement material. As explained above, replacement material can be tailored to the user of each device.

The replacement material can be pre-recorded commercials saved to the primary device 140's hard drive, commercials saved at the HE 120, or commercials from a different tuned channel that are tailored to the specific user. The remote device 150-2 tunes to that channel until the commercial break of the original presentation ends. Alternatively, the remote device only tunes to the alternate channel until any one or more commercials ends.

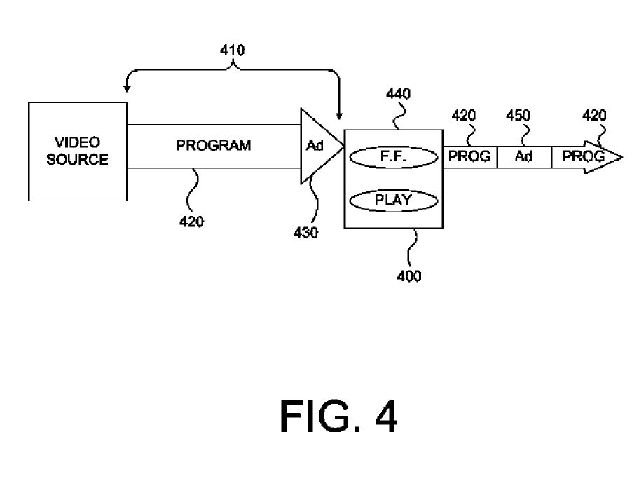

FIG. 4 illustrates the use of trick mode functionality 400 (e.g., pause, fast forward, rewind, skip ahead, or skip back functionality) while watching a presentation 410 made up of a program 420 and a commercial 430. Trick mode functionality 400 provides users with the opportunity to enhance the control of their viewing experience. The fast forward function 440 is most often used on commercials and therefore, could be used by the primary device 140 or the HE 120 to identify advertising opportunities in a presentation 410. As the fast forward function 440 is used when the commercial 430 begins, alternative commercial 450 will be inserted into the presentation 410 and replace the original commercial 430.

In one embodiment, a user's trick play functionality could be restricted while viewing a portion of a presentation, such as commercials. The trick play functionality, such as fast forward, would not work for certain commercials as specified, for example, by the local cable operator or the presentation programmer. The added or replaced material, such as new commercials, would also be unskippable when recorded to a storage device such as a DVD or when played from the hard drive of the primary device 140 to the remote device, such as 150-1, in a multi-room environment. Instead of fast forwarding through a commercial, an indication such as an icon or banner could appear that would indicate trick play was not allowed. At the end of the specified commercial, trick play could resume.

A multipurpose tag could be included in the presentation that would be recognized by software in the primary device 140 and the remote devices 150-1 to 150-n. The tags notifying the devices which commercials should preclude trick play. DPI standards would define an interface for command, control, and reporting information. DPI standards may also define ad insertion tags to signal the local video server to play a commercial and standardize the application programming interface (API) between servers and splicers. For example, a splice insert command is sent prior to an insertion tag, or splice point, to guarantee the proper timing and placement of inserted commercials. The insertion can be done by the local cable companies or even at the set-top boxes in the user home.

There are additional options for the commercial slots. For example, the multipurpose tags can signify where to insert an ad, whether or not to preclude trick play, and the duration of a commercial. The commercials slots could be persistent, meaning another product commercial would not be inserted over the specified commercial, but it could be updated by the company owning the commercial slot. The commercial slot could also preclude trick play for only a specified length of time, such as two weeks. For example, a tag corresponding with a commercial could expire after a period of time after which the tag would become inactive or replaceable. A non-persistent commercial slot could display a particular ad for a company during a specified length of time before the commercial slot could then display a commercial for a different company.

Another opportunity for ad insertion or replacement is during DVD playing, recording or copying. The primary device 140 can contain a means for copying a presentation to an alternative medium. For example, the presentation could be copied to a personal computer, an external hard drive, or to a VHS tape using a VCR. The presentation could also be burned to a DVD by using an internal or external DVD burner. Either DVD burner would allow prerecorded DVDs to be displayed on the local device 180 coupled to the primary device 140 or to any of the remote devices 150-1 to 150-n. The prerecorded DVDs could also be copied onto the hard drive in the primary device 140 using an internal or external DVD burner. Additional material such as commercials, logos, and previews could be added to the prerecorded DVD.

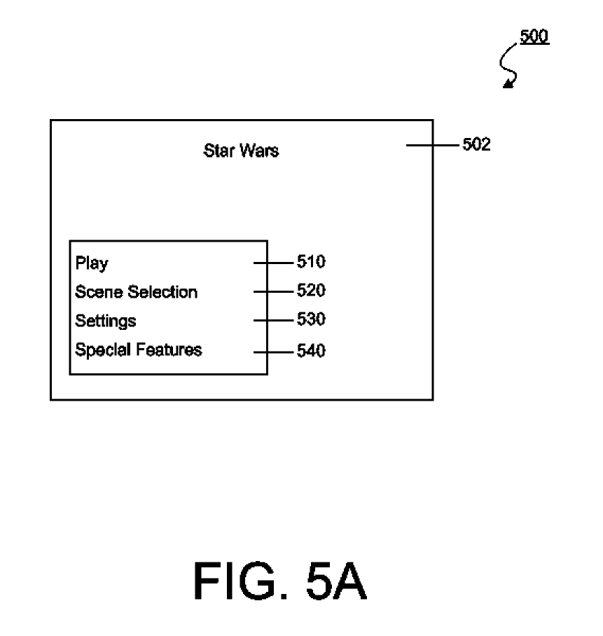

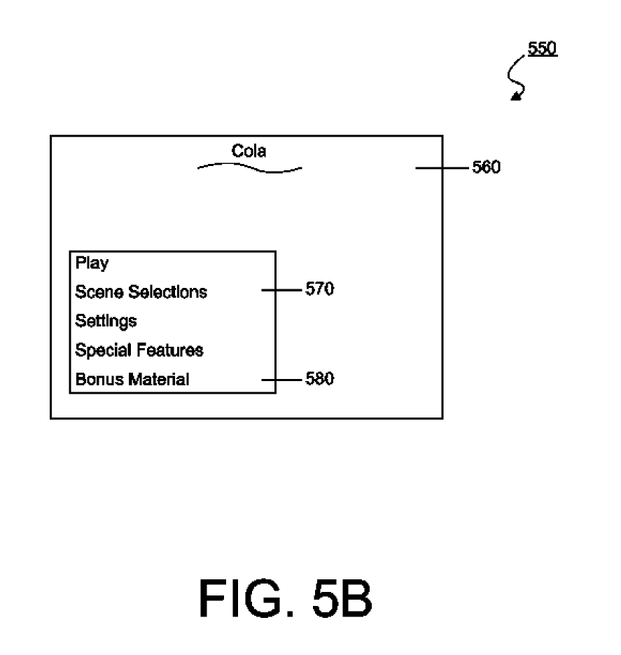

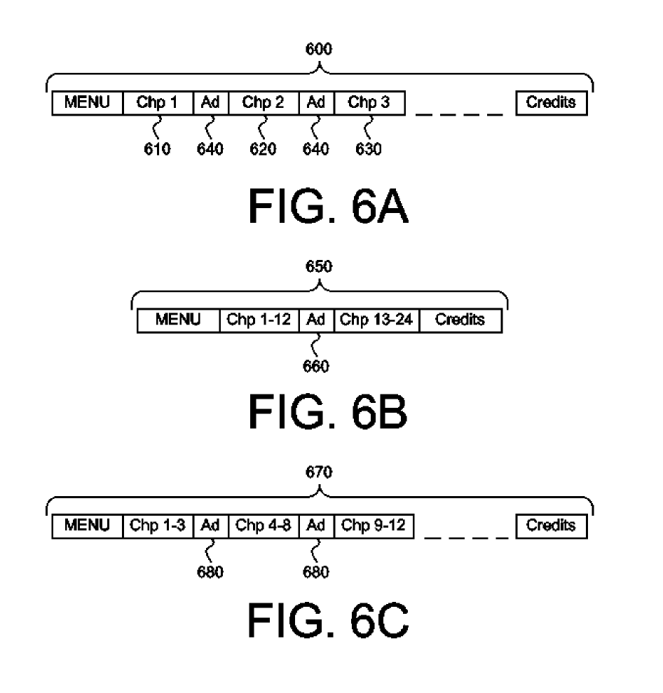

FIG. 5A illustrates one embodiment of a root menu 500 typical on store bought, or prerecorded, professional DVDs. A store bought DVD can be played from the primary device 140 and then seen at the same or different times on any one or more of the remote devices 150-1 to 150-n. Options within the root menu 500 typically include play 510, scene selections 520, settings 530, and special features 540. Other options may be included. Because the movie has already been broken up into chapters for the scene selection option, ads could easily be inserted to correspond with the beginning or end of one or more chapters. As shown in FIG. 6A, while a presentation 600 is playing, an advertisement 640 could be inserted and appear where there is a transition from one chapter to another. The commercials could have been previously downloaded and saved to the primary device 140 or the HE 120. Depending on user preferences or the DVD being played, corresponding commercials could be chosen and displayed. For example, during the presentation Star Wars, the inserted commercials could be for Star Wars merchandise. Therefore, commercials to be inserted could be selected based upon the original content of the DVD. The same commercials could be played on all devices 140 and 150-1 to 150-n or the commercials could be tailored to the user of each particular device. For example, the chosen commercials could be different for each device 140 or 150-1 to 150-n playing the movie from the DVD.

If the primary device 140 is coupled to an internal or external DVD burner, any tuned presentation recorded to the hard drive of the primary device 140 can be re-recorded onto a DVD. Commercials recorded from a tuned signal can be identified by the primary device 140 or the HE 120 and replaced with material, such as more current commercials or commercials tailored to specific users. Additionally, a menu 550, as shown in FIG. 5B, can be created and inserted when the presentation is encoded and burned to the DVD. The menu 550 can have a background for advertising 560, with material such as a commercial, logo, or a picture of a product. The menu 550 can also have an option for scene selections 570. This could break each presentation into chapters, such as on a professional DVD, based upon time intervals or ad-insertion tags. Scene selections could also be created to differentiate between separate presentations on the DVD. In another embodiment, the menu 550 can contain an option for bonus material 580, which could be commercials, previews, or other additional content. The DVD could also have PC readable files, such as HTML documents or executable files that pertain to the tuned presentation. For example, if a football game is being recorded to a DVD, statistics of the current teams and players or other football games could be included on the DVD.

It is also possible to copy the original content of a store bought DVD onto the hard drive of the primary device 140 and then compile the movie with an altered menu to be recorded onto a blank storage medium such as a DVD. The existing menu screen 500, for example, could be altered to have added or replaced material such as a commercial, logo, or a picture of a product as a background 560, as shown in FIG. 5B. An option to see commercials or movie or television previews could also be added as bonus material 580 on the menu 550.

FIGS. 6A-6C illustrate the various options for inserting advertisements into a store bought DVD. Because the presentation 600 has already been separated into chapters 610, 620, 630 for the scene selection option, ads 640 could easily be inserted between every chapter, such as between chapters 1 and 2, as shown in FIG. 6A. FIG. 6B depicts advertisements 660 added at specified times or time intervals. For example, the presentation 650 shows advertisements 660 inserted half way through the presentation. Another example would be to insert ads every 15 minutes. FIG. 6C illustrates a presentation 670 that has ads 680 inserted during chapter breaks at varying intervals, such as between chapters 3 and 4 and then again between chapters 8 and 9.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A method for inserting additional material in a prerecorded presentation, said method comprising the steps of:
receiving said prerecorded presentation from a first storage device;
storing said prerecorded presentation to a second storage device;
playing said prerecorded presentation from said second storage device;
identifying a break in said prerecorded presentation; and
inserting said additional material into said prerecorded presentation on said second storage device at said break.

2. The method of claim 1, further comprising the step of rerecording said presentation with said additional material to a third storage device.

3. The method of claim 1, further comprising the step of rerecording said prerecorded presentation with said additional material to a DVD.

4. The method of claim 1, wherein said identifying step comprises identifying said break as a transition between chapters.

5. The method of claim 1, wherein said inserting step comprises inserting additional material at the beginning or at the end of said prerecorded presentation.

6. The method of claim 1, wherein said inserting step comprises inserting additional material at a predetermined interval.

7. The method of claim 1, wherein said inserting step comprises selecting additional material based upon user preferences.

8. The method of claim 1, wherein said inserting step comprises selecting additional material based upon said prerecorded presentation.

9. The method of claim 1, further comprising the steps of:
identifying an existing ad in said prerecorded presentation; and
inserting said additional material into said prerecorded presentation in place of said identified existing ad.

10. A method for inserting material in a prerecorded presentation, said method comprising the steps of:
receiving said prerecorded presentation from a first storage device;
storing said prerecorded presentation to a second storage device; and
altering a menu of said prerecorded presentation with said inserted material.

11. The method of claim 10, further comprising the step of rerecording said presentation with said altered menu to a third storage device.

12. The method of claim 10, wherein said altering step comprises inserting a logo as said material.

13. The method of claim 10, wherein said altering step comprises inserting said material that depicts a product.

14. The method of claim 10, wherein said altering step comprises inserting a commercial as said material.

15. The method of claim 10, wherein said altering step comprises inserting a preview as said material.

16. The method of claim 10, wherein said altering step comprises inserting a computer readable file as said material.

17. The method of claim 10, wherein said altering step comprises inserting new material as said material in said prerecorded presentation.

18. The method of claim 10, wherein said altering step comprises inserting said material in place of original material in said prerecorded presentation.

19. A presentation altered to include ads residing on a storage device, said altered presentation comprising one of a plurality of ads inserted as a background to a menu of said altered presentation.

20. The altered presentation of claim 19, further comprising one of said ads inserted elsewhere in said altered presentation.

21. The altered presentation of claim 20, wherein said ad inserted elsewhere in said altered presentation is inserted at a predetermined interval.
